(19) United States
(12) Patent Application Publication
(10) Pub. No.: US 2025/0139199 A1
(43) Pub. Date: May 1, 2025

(54) AUTOMIZED GENERATION OF INSIGHTFUL AND CONFIDENT DATA INSIGHTS

(71) Applicant: Intuit, Inc., Mountain View, CA (US)

(72) Inventors: Vignesh THIRUKAZHUKUNDRAM SUBRAHMANIAM, Bangalore (IN); Arnab CHAKRABORTY, Bangalore (IN); Aditya SONI, Bangalore (IN); Sricharan KALLUR PALLI KUMAR, Milpitas, CA (US)

(21) Appl. No.: 18/497,884

(22) Filed: Oct. 30, 2023

(51) Int. Cl. G06F 17/18; G06F 40/40

(52) U.S. Cl. CPC G06F 17/18; G06F 40/40

(57) ABSTRACT

Certain aspects of the disclosure provide systems and methods for generating meaningful insights from a data frame based on an insight score. An insight score may quantify the significance and confidence of a given insight. Aspects of the disclosure provide for optimizing the most meaningful insight based on a greedy binary search approach. Aspects of the disclosure further provide for obtaining the optimal insight based on a gradient search approach.

### BACKGROUND

### Field

Aspects of the present disclosure relate to autonomous insight generation from multi-dimensional data.

### Description of Related Art

An insight is an interesting observation derived from underlying data. Generating insights from data is an important and widespread technical problem among organizations of all sorts. That is because even though data-driven organizations currently possess data (e.g., customer data) that is massive in terms of both volume and variety, insights based on that data are generally use-case-specific (bespoke) and, consequently, suffer from low user engagement and low domain coverage. One of the reasons for these problems is that insights relevant to one user may not be relevant to another user. Hence, resources spent on surfacing insights in a bespoke fashion often lead to waste and underutilized outputs.

Solutions are needed for automatically analyzing data to generate interesting and confident insights for end users.

### SUMMARY

Certain aspects provide a method, comprising: formulating two or more insights from a data frame; assigning a respective score for each respective insight of the two or more insights based on a significance of each respective insight and a confidence in each respective insight; and searching for an optimal insight among the two or more insights based on the respective score for each respective insight.

Other aspects provide processing systems configured to perform the aforementioned methods as well as those described herein; non-transitory, computer-readable media comprising instructions that, when executed by a processors of a processing system, cause the processing system to perform the aforementioned methods as well as those described herein; a computer program product embodied on a computer readable storage medium comprising code for performing the aforementioned methods as well as those further described herein; and a processing system comprising means for performing the aforementioned methods as well as those further described herein.

The following description and the related drawings set forth in detail certain illustrative features of one or more aspects.

### DESCRIPTION OF THE DRAWINGS

The appended figures depict certain aspects and are therefore not to be considered limiting of the scope of this disclosure.

FIG. 1 depicts an example insight generation system for generating one or more personalized, relevant, and useful insights.

FIG. 2 depicts an example process flow for generating one or more insights based on a data frame using a greedy search approach.

FIG. 3 depicts an example greedy tree for generating one or more insights.

FIG. 4 depicts an example insight dictionary.

FIG. 5 depicts an example process flow for generating one or more insights based on a data frame using a gradient based search approach.

FIG. 6 depicts an example method for generating two or more insights based on a data frame.

FIG. 7 depicts an example processing system with which aspects of the present disclosure can be performed.

To facilitate understanding, identical reference numerals have been used, where possible, to designate identical elements that are common to the drawings. It is contemplated that elements and features of one embodiment may be beneficially incorporated in other embodiments without further recitation.

### DETAILED DESCRIPTION

Aspects of the present disclosure provide apparatuses, methods, processing systems, and computer-readable mediums for autonomous insight generation, and in particular for generating insights that are both significant and confident in a computationally tractable way.

“Big data” presents significant opportunities for generating insights that may significantly impact many aspects of life. However, big data exists as both a solution and a problem because processing big data in a useful manner is computationally challenging and complex. For example, trying to select a set of most relevant data from a large set of multidimensional data for any particular insight may lead to intractable—for both human and machine—combinatorial search problems. Moreover, the heterogeneity of data within large big data sets creates technical problems for automatic processing, which generally works best when data is well structured and consistent. For these reasons, and others, big data is often touted more than it is exploited successfully.

Thus, a technical problem exists in the art in which there is a need for improved methods of generating insights based on data that is often voluminous, complex, multi-dimensional and/or incomplete.

Aspects described herein provide a technical solution for generating customized, relevant, and useful insights. In particular, aspects described herein relate to the automatic creation of so-called “insight trees,” which can be used to generate, from a complex data set, a rank-ordered set of top insights in terms of both significance and confidence. To do so, aspects described herein first formulate a set of non-obvious insights from the data using statistical hypothesis testing, which generates insight scores. Next, a greedy search approach is used to intelligently search through different pivots and groups of the data to determine the most meaningful insights in the rank-ordered fashion, e.g., based on the insight scores. Further, a large language model (LLM) may be used to present one or more insights to a user in a manner that is easily understandable.

Many technical benefits are provided by the aspects described herein, including enabling autonomous and continuous generation of insights based on large amounts of complex data with reduced computational complexity and resource usage compared to conventional, less effective techniques. Beneficially, aspects described herein eliminate the need for human specialists, e.g., data scientists, to generate insights in a bespoke, unscalable fashion. Thus, aspects described herein overcome a previously intractable computational problem, and allow for effective and automatic insight generation.

### Example Insight Generation System

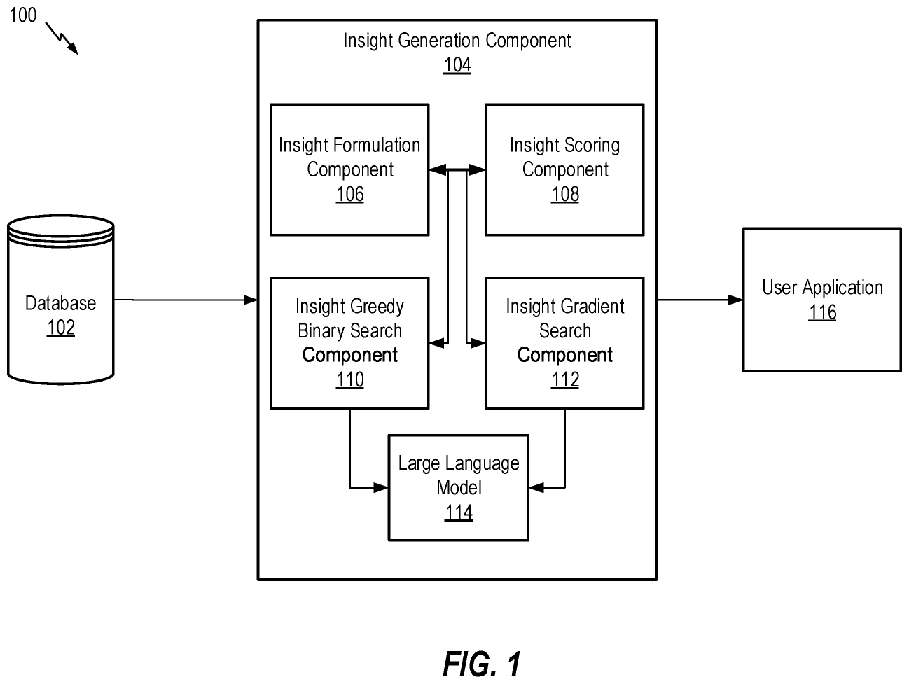

FIG. 1 depicts an example insight generation system 100 for generating one or more insights. In the context of system 100, an insight is a hypothesis based inference that is both non-obvious from mere presentation of the underlying data and holds true with a high degree of confidence, despite natural variations and incompleteness of the underlying data.

Insight generation system 100 includes a database 102 for storing data used by insight generation component 104 to generate insights. Data stored in database 102 may include multi-dimensional and tabular data, which may be referred to as data frames. For example, a data frame may be defined as [symbol] ₙ^{p}=(X₁, . . . , Xₚ)_{n×p}, where where n and p are dimensions of the data frame. Data in data frame [symbol] may be arranged in rows and columns. Examples described herein include accounting data, however, the systems and methods herein may be implemented on any manner of data.

Insight generation component 104 is configured to generate insights using data from database 102. As described in further detail herein, a hypothesis-based inference is generated, scored with an insight metric, called an insight score, and ranked to generate the most meaningful insights.

Insight generation component 104 includes an insight formulation component 106 configured to formulate one or more insights into the data from database 102, for example, data frame [symbol] . In some embodiments, an insight may be formulated as a hypothesis to be tested, as described herein, to generate an insight. As such, hypothesis testing based on variables (e.g., X₁) from data frame [symbol] may form the basis of generated insights.

For example, a hypothesis may be “the average amount billed in Gross Sales account in the month of January is on an average X % higher/lower as compared to other months.” Another example hypothesis may be “the average churn rate of customers coming through XYZ channel is X % higher/lower for new-to-file customers as compared to other customers.”

In some embodiments, a hypothesis may be represented as a conditional test of hypothesis (CTH) for the variable Xₖ. The CTH may be denoted as [symbol] (Xₖ; f(⋅)g(⋅). The hypothesis is tested through a null hypothesis H₀: μ_{A}=μ_{A}_{^{c}} versus an alternative hypothesis H₁: μ_{A}≠μ_{A}_{^{c}}, where μ_{A}= [symbol] (f(Xₖ)|A:=g(Xₖ)>0) and μ_{A}_{^{c}}= [symbol] (f(Xₖ)|A:=g(Xₖ)≤0) for a function g: [symbol] ^{p-1}→ [symbol] .

The distribution of the data frame [symbol] is defined as:

$$T = \frac{f ( {\overline{X}}_{A} ) - f ( {\overline{X}}_{{A}^{c}} )}{s . e . ( f ( {\overline{X}}_{A} ) - f ( {\overline{X}}_{{A}^{c}} ) )} ∼ {H}_{0} t ( 0 , df ( {n}_{1} , {n}_{2} ) ) .$$

For example, the hypothesis “the average amount billed in Gross Sales account in the month of January is on an average X % higher/lower as compared to other months,” the is defined as: g(Xₖ)=I(X₁=Gross Sales)×=I(X₂=January).

A hypothesis may be formulated to test other distributional parameters, for example, correlation, variance, trend, seasonality, anomaly, and the like. The hypothesis formulated for a trend, for example, may be tested by determining whether the slope associated with f(Xₖ) equals 0, versus the slope associated with f(Xₖ) does not equal 0.

Insight generation component 104 further includes an insight scoring component 108 configured to assign an insight score to each hypothesis by testing the hypothesis against the data frame [symbol] . The insight score may be used to differentiate and identify interesting insights.

The insight score is generated by testing the formulated hypothesis on the data frame [symbol] . A first set of data is defined as the pivot or group of rows from data frame [symbol] that satisfy g(Xₖ)>0 indicating the pivot or group of rows have an interesting distribution in terms of f(Xₖ). The second set is defined as the rest of the rows or pivot from data frame [symbol] which do not satisfy g(Xₖ)>0. In some embodiments, the hypothesis is tested as the means of f(Xₖ) being equal, e.g., H₀: μ_{A}=μ_{A}_{^{c}}, versus a two-sided alternative, not equal, e.g., H₁: μ_{A}≠μ_{A}_{^{c}}. In some embodiments, the hypothesis is tested as the means of f(Xₖ) being equal, e.g., H₀: μ_{A}=μ_{A}_{^{c}} versus a one sided alternative, greater than, e.g., H₁: μ_{A}<μ_{A}_{^{c}}, or less than, e.g., H₁: μ_{A}>μ_{A}_{^{c}}.

The insight score may be based the significance of the hypothesis. The significance may indicate how different the first set and the second set are in terms of means of f(Xₖ). In one example, the significance of the hypothesis is the probability the alternative hypothesis is true, which may be quantified as 1−p-value. The p-value is defined as: [symbol] (|T|>T_{observed}|H₀) or the probability the distribution T is greater than the observed distribution T_{observed} given the null hypothesis H₀: μ_{A}=μ_{A}_{^{c}} is true. A higher value of the significance, 1−p-value, may indicate the hypothesis is more meaningful.

Additionally, the insight score may be based on the confidence of the hypothesis. The confidence of the hypothesis indicates how supportive the data is of the hypothesis. In some embodiments, the confidence is quantified as the proportion of rows that satisfy the condition g(Xₖ)>0, or the proportion of rows that have the desired interesting distribution compared to the rows that do not satisfy the condition g(Xₖ)>0, and thus do not have the desired interesting distribution.

In some embodiments, the confidence is based on the power of the hypothesis at a given minimum detectable effect. A minimum detectable effect is the effect size, which if it truly exists, can be detected with a given probability with a statistical test of a certain significance level. The power may be defined as:

$$\begin{matrix}power = ( \vert T \vert > {T}_{( \frac{1 - α}{2} )} \vert {H}_{1} ) \\ = ( T > {T}_{( \frac{1 - α}{2} )} - \frac{\vert {μ}_{A} - {μ}_{{A}^{c}} \vert}{s . e . ( f ( {\overline{X}}_{A} ) - f ( {\overline{X}}_{{A}^{c}} ) )} ) \\ + ( \vert T \vert < {t}_{( \frac{1 - α}{2} )} - \frac{\vert {μ}_{A} - {μ}_{{A}^{c}} \vert}{s . e . ( f ( {\overline{X}}_{A} ) - f ( {\overline{X}}_{{A}^{c}} ) )} )\end{matrix}$$

where α is the probability of rejecting the null hypothesis in favor of a false hypothesis.

Beneficially, scoring a hypothesis with the confidence ensures that even with significant distributional disparity, quantified by the significance, the hypothesis supported, and not a serendipitous observation, quantified by the confidence.

In some embodiments, the insight score is a harmonic mean of the significance and the confidence. The harmonic mean of(x₁, . . . , xₘ) is defined as:

$$H ( {x}_{1} , … , {x}_{m} ) ( \frac{m}{{\sum }_{i = 1}^{m} \frac{1}{{x}_{i}} .} ) .$$

Beneficially, by calculating the harmonic mean, if either the significance or the confidence is close to 0, the insight score will also be closer to 0. In some embodiments, a lower score, e.g., closer to 0, indicates a hypothesis is less insightful. A higher score, e.g., closer to 1, may indicate a hypothesis is more insightful.

In some embodiments, the insight score is a geometric mean of the significance and the confidence. The geometric mean of (x₁, . . . , xₘ) is defined as:

$${( {\prod }_{i = 1}^{m} {x}_{i} )}^{\frac{1}{m}} = \sqrt[m]{( {x}_{1} , … , {x}_{m} )} .$$

Beneficially, the geometric mean may be useful where there is a multiplicative relationship between the significance and the confidence.

In some embodiments, the insight score may be based on the number of rows in A, A^{c}, n₁, n₂ respectfully:

$$Insight Score = ( σ ( \vert T \vert \times {( \frac{4 {n}_{1} {n}_{2}}{{( {n}_{1} + {n}_{2} )}^{2}} )}^{} ,$$

wherein T is the distribution of the data frame [symbol] and is defined as

$$T = \frac{f ( {\overline{X}}_{A} ) - f ( {\overline{X}}_{{A}^{c}} )}{s . e f ( {\overline{X}}_{A} ) - f ( {\overline{X}}_{{A}^{C}} )} ∼ {H}_{0} t ( 0 , df ( {n}_{1} , {n}_{2} ) ) .$$

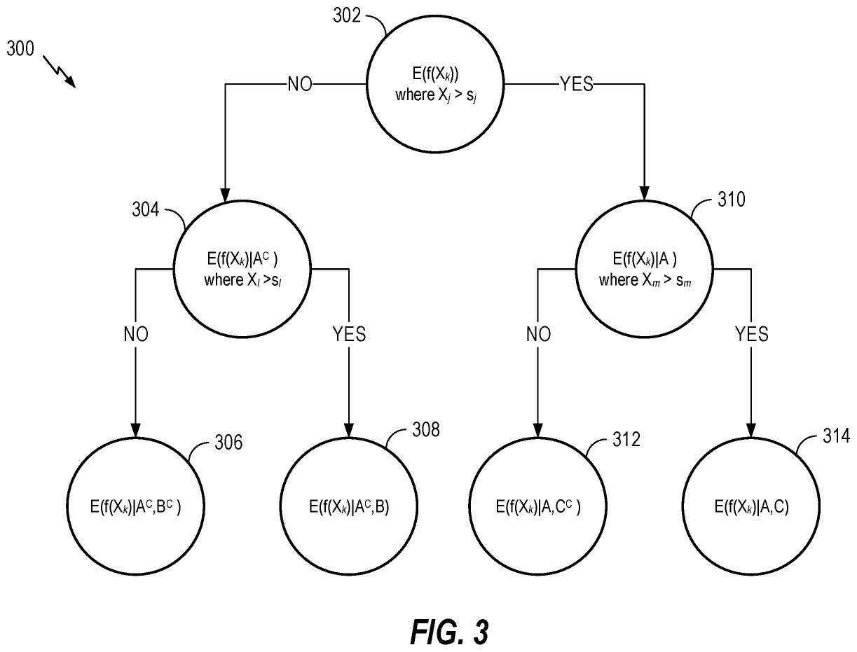

Insight generation component 104 includes an insight greedy binary search component 110. As described below with respect to FIG. 3, a greedy binary search component may be configured to search through the data frame [symbol] to find the most significant and confident insights. Beneficially, the insight greedy binary search component identifies insights with advantageous interpretability and fast compute.

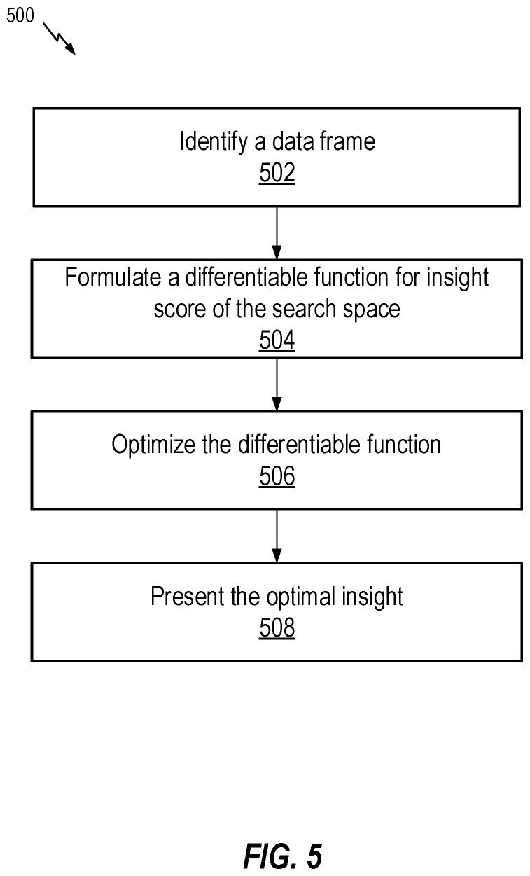

Insight generation component 104 further includes an insight gradient search component 112. As described below with respect to FIG. 5, a gradient search component may be used to search through the data frame [symbol] to find the optimal insight based on the insight score. The insight gradient based search component 112 may beneficially identify the optimal insights in terms of the insight score, balancing reduced computational complexity and saved processing resources by efficiently searching for insights through maximizing the insight score, with some reduced interpretability.

Insight generation component 104 further includes a large language model 114 configured to process generated insights into a human language representation, such as for presentation to a user through a user application 116. Insights may be presented in a human language, for example, through text, in a manner readable by users.

### Example Process Flow for Generating Insights

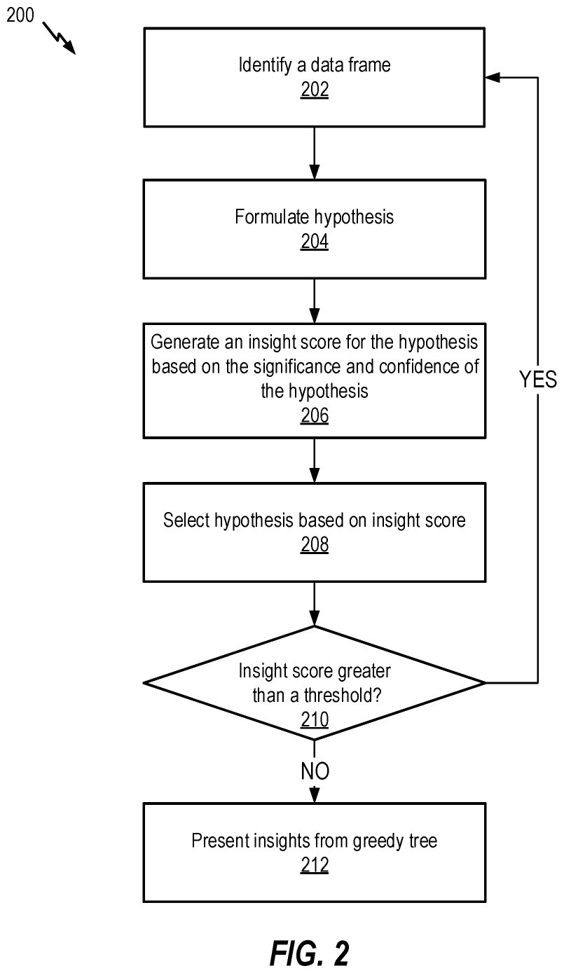

FIG. 2 depicts an example process flow 200 for generating one or more insights into a data frame, e.g., data frame [symbol] . As described herein, an insight may be determined as a hypothesis-based inference based on the data frame, where the insight is generally characterized as being not obvious from the mere presentation of the underlying data. Aspects of flow 200 may be performed, for example, by insight generation component 104.

Flow 200 begins at step 202 with considering a data frame, for example, data frame [symbol] ₙ^{p}=(X₁, . . . , Xₚ)_{n×p}, where where n and p are dimensions of the data frame, such as stored in database 102 in FIG. 1.

Flow 200 proceeds to step 204 with formulating a hypothesis to be tested based on variables (e.g., X₁) from data frame [symbol] to generate insights. Specifically, a hypothesis is tested and scored to generate an insight. For example, a hypothesis may be “the average amount billed in Gross Sales account in the month of January is on an average X % higher/lower as compared to other months.”

As described, a hypothesis may be represented as the CTH for the variable Xₖ and defined as a null hypothesis H₀: μ_{A}=μ_{A}_{^{c}} versus an alternative hypothesis H₁: μ_{A}≠μ_{A}_{^{c}}, where μ_{A}= [symbol] (f(Xₖ)|A:=g(Xₖ)>0) and μ_{A}_{^{c}}= [symbol] (f(Xₖ)|A:=g(Xₖ)≤0) for a function g: [symbol] ^{p-1}→ [symbol] . The CTH may thus be denoted as [symbol] (Xₖ; f(⋅)g(⋅)).

For each column in the data frame [symbol] ₙ^{p}, the unique values are grouped, and looped over to form a first hypothesis g(Xₖ). This is repeated for all possible combinations of (A,A^{c}). In some embodiments, columns of the data frame [symbol] ₙ^{p} are randomly sampled to capture different combinations of columns for formulating hypotheses.

Flow 200 then proceeds to step 206 with generating an insight score for each hypothesis g(Xₖ) determined at step 204. As described herein, the insight score may be determined based on the significance and confidence of a hypothesis.

In some embodiments, the significance may be quantified as 1−p-value. The p-value is defined as: [symbol] (|T|>T_{observed}|H₀) or the probability the distribution T is greater than the observed distribution T_{observed} given the null hypothesis. A higher value of the significance, 1−p-value, may indicate the hypothesis may be more interesting.

In some embodiments, the confidence is quantified as the proportion of rows that satisfy the condition g(Xₖ)>0, or the proportion of rows that have the desired interesting distribution compared to the rows that do not satisfy the condition g(Xₖ)>0, and thus do not have the desired interesting distribution.

In some embodiments, the confidence is quantified as the power of the hypothesis test at a minimum detectable effect. The power may be defined as:

$$\begin{matrix}power = ( \vert T \vert > {T}_{( \frac{1 - α}{2} )} \vert {H}_{1} ) \\ = ( T > {T}_{( \frac{1 - α}{2} )} - \frac{\vert {μ}_{A} - {μ}_{{A}^{c}} \vert}{s . e . ( f ( {\overline{X}}_{A} ) - f ( {\overline{X}}_{{A}^{c}} ) )} ) \\ + ( \vert T \vert < {t}_{( \frac{1 - α}{2} )} - \frac{\vert {μ}_{A} - {μ}_{{A}^{c}} \vert}{s . e . ( f ( {\overline{X}}_{A} ) - f ( {\overline{X}}_{{A}^{c}} ) )} ) .\end{matrix}$$

Flow 200 then proceeds to step 208 with selecting the hypothesis g(Xₖ) with the highest insight score as the root node based on (A, A^{c})=(Xⱼ>sⱼ, Xⱼ≤sⱼ). For example, with reference to FIG. 3, the root node 302 is the hypothesis g(Xₖ).

Flow 200 then proceeds to step 210 with comparing the insight score of the selected hypothesis to a threshold. If the insight score is greater than the threshold, then, steps 202-208 are repeated to form a child node, for example, node 304 in FIG. 3, considering a subset data frame, g(X₁)>0, where X₁ is the column with the maximum contribution to the insight score of the prior node.

Steps 202-210 are repeated recursively on further subset data frames to reveal further granular insights until the highest insight score for a selected hypothesis is less than a threshold. For example, for node 304 in FIG. 3, a hypothesis g(Xₖ) is formulated for a subset A^{c} and the split is at A^{c}=(Xₗ>sₗ, Xₗ≤sₗ). For node 310 in FIG. 3, a hypothesis g(Xₖ) is formulated for (A)=(Xₘ>sₘ, Xₘ≤sₘ).

In the depicted example in FIG. 3, the insight tree 300 comprises node 302 representing the first candidate g(Xₖ), and nodes 304 and node 306 representing the subsequent candidates for g(Xₖ). Finally, leaf nodes 308, 310, 312, and 314 represent further subsequent candidates for g(Xₖ).

Thus, for each subsequent feature and split, the greedy search method searches for a substructure containing the optimal insight, measured by the maximum insight score. By iteratively reducing the search space, the computational complexity of searching through all the possible insights is eliminated and the optimal insight is readily obtained in a computationally efficient manner.

For example, for a given data frame, the column with the maximum insight score may be “Product.” The unique value providing the best split is “Golf Shoes” versus not golf shoes. Thus, node 302 represents “Product” and node 304 represents “Golf Shoes.” The next unique value providing the next best split is “Transaction Date” in the month of “January 2023” versus not in that month. Thus, node 308 represents “January 2023.” Together, these nodes represent an optimal insight.

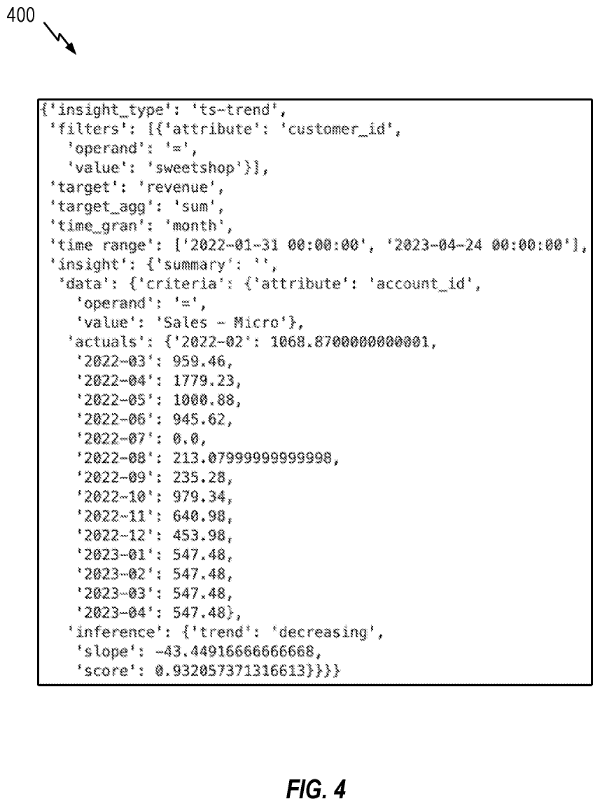

If at step 210, the highest insight score is not greater than the threshold, then flow 200 proceeds to step 212, with presenting the insights from the greedy tree (e.g., tree 300) generated through iteration of steps 202-210. The insights may be presented as a dictionary, for example, a Python dictionary or a JSON format. For example, FIG. 4 depicts an example dictionary 400 representing an exemplary insight.

In some embodiments, a large language model, such as large language model 114 in FIG. 1, may process the generated insight(s) to present the insight(s) in a human language. In some embodiments, the insight(s) may be process using a rules-based approach to convert the insight to presentation in a human language. Thus, the above example may read: “For golf shoes, the average transaction amount per sales order is $13 higher in the month of January 2023 as compared to other months.” Beneficially, the insights may be presented in a reader-friendly manner, for example, in a user application, such as an accounting-data related insight within an accounting application.

Note that FIG. 2 is just one example of a process flow, and other flows including fewer, additional, or alternative steps are possible consistent with this disclosure.

### Example Insight Gradient

FIG. 5 depicts an example gradient based search process flow 500 for generating insights. As described herein, searching through all possible values of g(Xₖ) is computationally expensive and complex. A gradient-based search approach may be used to optimize for the most interesting insights in a computationally efficient matter, because all possible values need not be searched.

At step 502, a data frame [symbol] ₙ^{p}=(X₁, . . . , Xₚ)_{n×p}, where n and p are dimensions of the data frame is identified and considered.

At step 504, the search space, data frame [symbol] , may be represented through a differentiable function. In one example, the insight score may be determined based on representing the hypothesis through a membership function with soft-thresholding: a=σ(θ), θ_{n×1}∈ [symbol] ⁿ.

The distribution T is defined as

$$T = ,$$

given

$$= \frac{{a}^{′} \cdot f ( {X}_{k} )}{\sum ( α )} = \frac{{( 1 - a )}^{′} \cdot f ( {X}_{k} )}{\sum ( 1 - a )} , {S}_{A} = \frac{s . e . ( f ( {X}_{k} ) ) {( {a}^{′} \cdot a )}^{0.5}}{\sum ( a )} , {S}_{{A}^{c}} = \frac{s . e . ( f ( {X}_{k} ) ) {( {( 1 - a )}^{′} \cdot ( 1 - a ) )}^{0.5}}{\sum ( 1 - a )} ,$$

where [symbol] and [symbol] are the membership functions, and where s_{A} and s_{A}_{^{c}} are the soft thresholding operators. Given a target function:

$$𝕀 ( θ ) = ( σ ( \vert T \vert \times {( \frac{4 \sum ( a ) \sum ( 1 - a )}{{( \sum ( α ) + \sum ( 1 - α ) )}^{2}} )}^{}$$

the sequence is

$$= {argmax}_{θ} ( θ ) , = {argmax}_{θ} ( θ ) \times ( 1 - {a}^{′} \cdot , … ) .$$

As described herein, the insight score may be computed based on the significance and confidence of the hypothesis:

$$= \frac{{a}^{′} \cdot f ( {X}_{k} )}{\sum ( α )} = \frac{{( 1 - a )}^{′} \cdot f ( {X}_{k} )}{\sum ( 1 - a )} , {S}_{A} = \frac{s . e . ( f ( {X}_{k} ) ) {( {a}^{′} \cdot a )}^{0.5}}{\sum ( a )} , {S}_{{A}^{c}} = \frac{s . e . ( f ( {X}_{k} ) ) {( {( 1 - a )}^{′} \cdot ( 1 - a ) )}^{0.5}}{\sum ( 1 - a )} .$$

In some embodiments, the insight score may be based on a harmonic mean of the significance of each respective insight and the confidence in each respective insight. In some embodiments, the insight score may be based on a geometric mean of the significance of each respective insight and the confidence in each respective insight.

At step 506, the differentiable function for insight score, defined at step 504, is optimized through a differentiable optimization framework. For example, a gradient based optimization framework, such as Torch, may be used to generate optimal insights. A gradient optimization framework uses gradients of the differentiable function to search for an optimum point, which may be the optimal insight.

At step 508, the optimal insight generated at step 506 may be presented. For example, as described herein, the insights may be presented as a dictionary, for example, a Python dictionary or a JSON format. FIG. 4 depicts an example dictionary 400 representing an exemplary insight. Further, insights may be processed by a large language model, such as large language model 114 in FIG. 1, to present the insight in a human language. Beneficially, the insights may be presented in a reader-friendly manner, for example, in a user application, such as an accounting-data related insight within an accounting application.

Note that FIG. 5 is just one example of a process flow, and other flows including fewer, additional, or alternative steps are possible consistent with this disclosure.

### Example Method for Generating Insights

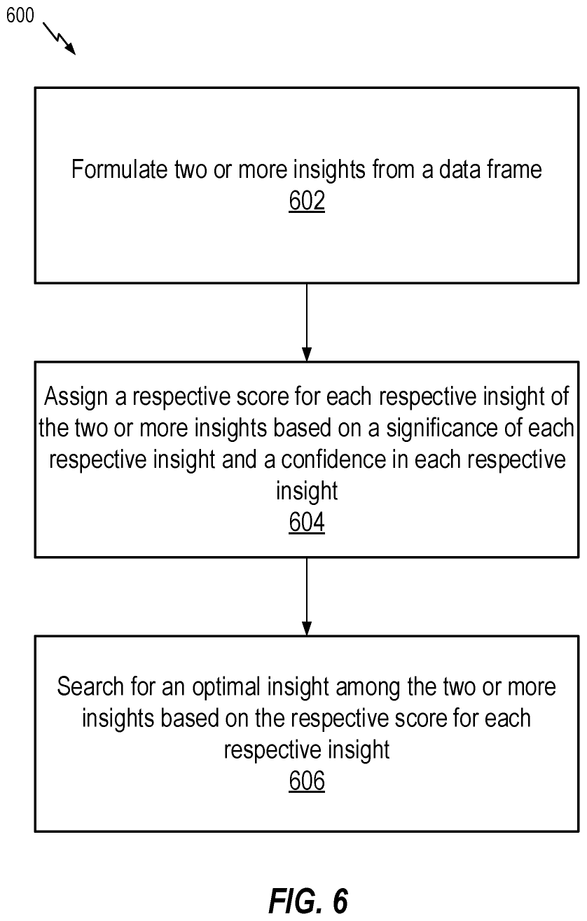

FIG. 6 depicts an example method 600 for generating an optimal insight into a data frame. Aspects of method 600 may be performed, for example, by insight generation component 104 in FIG. 1.

Initially, method 600 begins at step 602 with formulating two or more insights from a data frame. For example, a data frame may be defined as [symbol] ₙ^{p}=(X₁, . . . , Xₚ)_{n×p}, where where n and p are dimensions of the data frame. Data in data frame [symbol] may be arranged in rows and columns.

Method 600 proceeds to step 604 with assigning a respective score for each respective insight of the two or more insights based on a significance of each respective insight and a confidence in each respective insight.

In some embodiments, the respective score for each respective insight of the two or more insights comprises a harmonic mean of the significance of each respective insight and the confidence in each respective insight.

In some embodiments, the respective score for each respective insight of the two or more insights comprises a geometric mean of the significance of each respective insight and the confidence in each respective insight.

Method 600 then proceeds to step 606 with searching for an optimal insight among the two or more insights based on the respective score for each respective insight.

In some embodiments, method 600 further comprises representing each respective insight of the two or more insights as a conditional test of hypothesis. In some embodiments, an insight may be represented as a conditional test of hypothesis (CTH) for the variable Xₖ and defined as a null hypothesis H₀: μ_{A}=μ_{A}_{^{c}} versus an alternative hypothesisH₁: μ_{A}≠μ_{A}_{^{c}}, where μ_{A}= [symbol] (f(Xₖ)|A:=g(Xₖ)>0) and μ_{A}_{^{c}}= [symbol] (f(Xₖ)|A:=g(Xₖ)≤0) for a function g: [symbol] ^{p-1}→ [symbol] . The CTH may thus be denoted as [symbol] (Xₖ; f(⋅)g(⋅)).

In some embodiments, the significance of the insight is computed based on a p-value of the insight. The significance may indicate how different the first set and the second set are in terms of means of f(Xₖ). In one example, the significance of the hypothesis is the probability the alternative hypothesis is true, which may be quantified as 1−p-value. The p-value is defined as: [symbol] (|T|>T_{observed}|H₀) or the probability the distribution T is greater than the observed distribution T_{observed} given the null hypothesisH₀: μ_{A}=μ_{A}_{^{c}} is true. A higher value of the significance, 1−p-value, may indicate the hypothesis is more meaningful.

In some embodiments, method 600 further comprises computing the confidence in each respective insight based on a power of the respective insight at a minimum detectable effect. A minimum detectable effect is the effect size, which if it truly exists, can be detected with a given probability with a statistical test of a certain significance level. The power may be defined as:

$$\begin{matrix}power = ( \vert T \vert > {T}_{( \frac{1 - α}{2} )} \vert {H}_{1} ) \\ = ( T > {T}_{( \frac{1 - α}{2} )} - \frac{\vert {μ}_{A} - {μ}_{{A}^{c}} \vert}{s . e . ( f ( {\overline{X}}_{A} ) - f ( {\overline{X}}_{{A}^{c}} ) )} ) \\ + ( \vert T \vert < {t}_{( \frac{1 - α}{2} )} - \frac{\vert {μ}_{A} - {μ}_{{A}^{c}} \vert}{s . e . ( f ( {\overline{X}}_{A} ) - f ( {\overline{X}}_{{A}^{c}} ) )} )\end{matrix}$$

where α is the probability of rejecting the null hypothesis in favor of a false hypothesis.

In some embodiments, the data frame comprises two or more rows of data; and the confidence of the insight is computed based on a proportion of rows of the data frame satisfying the insight to rows of the data frame not satisfying the insight. For example, a first set of data is defined as the pivot or group of rows from data frame [symbol] that satisfy g(Xₖ)>0 indicating the pivot or group of rows have an interesting distribution in terms of f(Xₖ). The second set is defined as the rest of the rows or pivot from data frame [symbol] which do not satisfy g(Xₖ)>0. The confidence may be computed as the proportion of the first set to the second set.

In some embodiments, searching for the optimal insight among the two or more insights based on the respective score for each respective insight comprises: growing a tree over the data frame utilizing a greedy binary search algorithm, comprising: selecting a first node for the tree based on one of the two or more insight based on a maximum of the respective score for each respective insight; determining a branch for the first node based on two or more additional insights from the data frame based on the first node; and selecting a second node based on one of the two or more additional insights based on a maximum of a respective score for each respective insight of the two or more additional insights, for example, as described with respect to FIG. 2.

In some embodiments, searching for the optimal insight among the two or more insights based on the respective score for each respective insight comprises utilizing a gradient based search, for example, as described with respect to FIG. 5.

In some embodiments, method 600 further comprises generating a human language representation of the optimal insight with a large language model, for example, large language model 114 in FIG. 1.

Note that method 600 is just one example of a method, and other methods including fewer, additional, or alternative steps are possible consistent with this disclosure.

### Example Processing System for Generating Insights

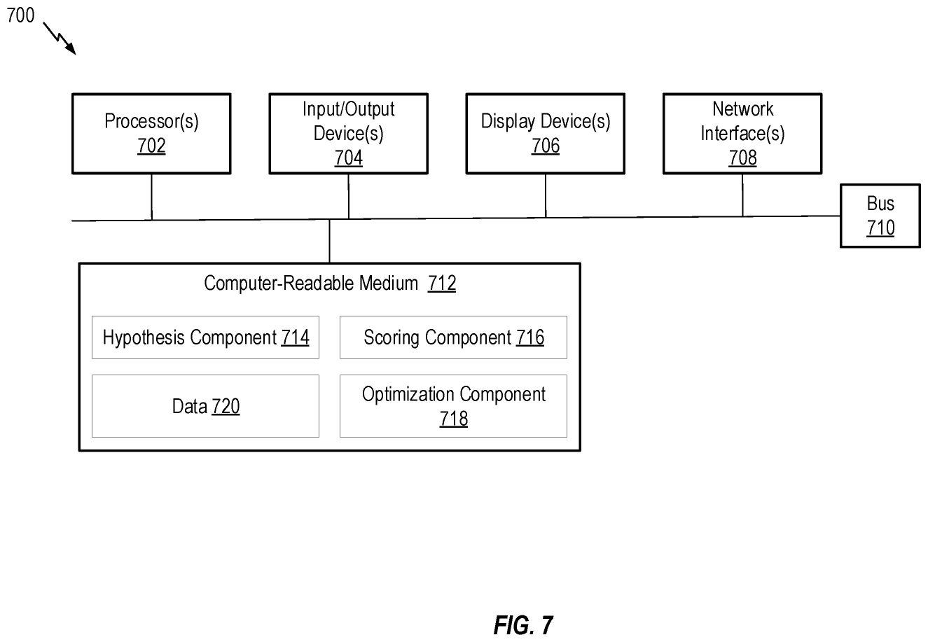

FIG. 7 depicts an example processing system 700 configured to perform various aspects described herein, including, for example, flow 200 as described above with respect to FIG. 2, flow 500 as described above with respect to FIG. 5, or method 600 as described above with respect to FIG. 6.

Processing system 700 is generally an example of an electronic device configured to execute computer-executable instructions, such as those derived from compiled computer code, including without limitation personal computers, tablet computers, servers, smart phones, smart devices, wearable devices, augmented and/or virtual reality devices, and others.

In the depicted example, processing system 700 includes one or more processors 702, one or more input/output devices 704, one or more display devices 706, one or more network interfaces 708 through which processing system 700 is connected to one or more networks (e.g., a local network, an intranet, the Internet, or any other group of processing systems communicatively connected to each other), and computer-readable medium 712. In the depicted example, the aforementioned components are coupled by a bus 710, which may generally be configured for data exchange amongst the components. Bus 710 may be representative of multiple buses, while only one is depicted for simplicity.

Processor(s) 702 are generally configured to retrieve and execute instructions stored in one or more memories, including local memories like computer-readable medium 712, as well as remote memories and data stores. Similarly, processor(s) 702 are configured to store application data residing in local memories like the computer-readable medium 712, as well as remote memories and data stores. More generally, bus 710 is configured to transmit programming instructions and application data among the processor(s) 702, display device(s) 706, network interface(s) 708, and/or computer-readable medium 712. In certain embodiments, processor(s) 702 are representative of a one or more central processing units (CPUs), graphics processing unit (GPUs), tensor processing unit (TPUs), accelerators, and other processing devices.

Input/output device(s) 704 may include any device, mechanism, system, interactive display, and/or various other hardware and software components for communicating information between processing system 700 and a user of processing system 700. For example, input/output device(s) 704 may include input hardware, such as a keyboard, touch screen, button, microphone, speaker, and/or other device for receiving inputs from the user and sending outputs to the user.

Display device(s) 706 may generally include any sort of device configured to display data, information, graphics, user interface elements, and the like to a user. For example, display device(s) 706 may include internal and external displays such as an internal display of a tablet computer or an external display for a server computer or a projector. Display device(s) 706 may further include displays for devices, such as augmented, virtual, and/or extended reality devices. In various embodiments, display device(s) 706 may be configured to display a graphical user interface.

Network interface(s) 708 provide processing system 700 with access to external networks and thereby to external processing systems. Network interface(s) 708 can generally be any hardware and/or software capable of transmitting and/or receiving data via a wired or wireless network connection. Accordingly, network interface(s) 708 can include a communication transceiver for sending and/or receiving any wired and/or wireless communication.

Computer-readable medium 712 may be a volatile memory, such as a random access memory (RAM), or a nonvolatile memory, such as nonvolatile random access memory (NVRAM), or the like. In this example, computer-readable medium 712 includes hypothesis component 714, scoring component 716, optimization component 718, and data 720.

In certain embodiments, hypothesis component 714 is configured to formulating two or more insights from a data frame stored as data 720, for example, as described with respect to FIGS. 1, 2, 5, and 6.

In certain embodiments, scoring component 716 is configured to assigning a respective score for each respective insight of the two or more insights, for example, as described with respect to FIGS. 1, 2, 5, and 6.

In certain embodiments, optimization component 718 is configured to assigning a respective score for each respective insight of the two or more insights, for example, as described with respect to FIGS. 1, 2, 5, and 6. In some embodiments, the optimization component comprises a greedy binary search component, for example, insight greedy binary search component 110 in FIG. 1. In some embodiments, the optimization component comprises a gradient search component, for example, insight gradient search component 112 in FIG. 1.

Note that FIG. 7 is just one example of a processing system consistent with aspects described herein, and other processing systems having additional, alternative, or fewer components are possible consistent with this disclosure.

### Example Clauses

Implementation examples are described in the following numbered clauses:

Clause 1: A method, comprising: formulating two or more insights from a data frame; assigning a respective score for each respective insight of the two or more insights based on a significance of each respective insight and a confidence in each respective insight; and searching for an optimal insight among the two or more insights based on the respective score for each respective insight.

Clause 2: The method of Clause 1, further comprising representing each respective insight of the two or more insights as a conditional test of hypothesis.

Clause 3: The method of Clause 2, wherein the significance of each respective insight is computed based on a p-value of the respective insight.

Clause 4: The method of any one of Clauses 1-3, further comprising computing the confidence in each respective insight based on a power of the respective insight at a minimum detectable effect.

Clause 5: The method of any one of Clauses 1-3, wherein: the data frame comprises two or more rows of data; and the confidence of each respective insight is computed based on a proportion of rows of the data frame satisfying the respective insight to rows of the data frame not satisfying the respective insight.

Clause 6: The method of any one of Clauses 1-5, wherein searching for the optimal insight among the two or more insights based on the respective score for each respective insight comprises: growing a tree over the data frame utilizing a greedy binary search algorithm, comprising: selecting a first node for the tree based on one of the two or more insight based on a maximum of the respective score for each respective insight; determining a branch for the first node based on two or more additional insights from the data frame based on the first node; and selecting a second node based on one of the two or more additional insights based on a maximum of a respective score for each respective insight of the two or more additional insights.

Clause 7: The method of any one of Clauses 1-6, wherein searching for the optimal insight among the two or more insights based on the respective score for each respective insight comprises utilizing a gradient based search.

Clause 8: The method of any one of Clauses 1-7, further comprising generating a human language representation of the optimal insight with a large language model.

Clause 9: The method of any one of Clauses 1-8, wherein the respective score for each respective insight of the two or more insights comprises a harmonic mean of the significance of each respective insight and the confidence in each respective insight.

Clause 10: The method of any one of Clauses 1-8, wherein the respective score for each respective insight of the two or more insights comprises a geometric mean of the significance of each respective insight and the confidence in each respective insight.

A processing system, comprising: a memory comprising computer-executable instructions; and a processor configured to execute the computer-executable instructions and cause the processing system to perform a method in accordance with any one of Clauses 1-10.

Clause 11: A processing system, comprising means for performing a method in accordance with any one of Clauses 1-10.

Clause 12: A non-transitory computer-readable medium storing program code for causing a processing system to perform the steps of any one of Clauses 1-10.

Clause 13: A computer program product embodied on a computer-readable storage medium comprising code for performing a method in accordance with any one of Clauses 1-10.

### Additional Considerations

The preceding description is provided to enable any person skilled in the art to practice the various embodiments described herein. The examples discussed herein are not limiting of the scope, applicability, or embodiments set forth in the claims. Various modifications to these embodiments will be readily apparent to those skilled in the art, and the generic principles defined herein may be applied to other embodiments. For example, changes may be made in the function and arrangement of elements discussed without departing from the scope of the disclosure. Various examples may omit, substitute, or add various procedures or components as appropriate. For instance, the methods described may be performed in an order different from that described, and various steps may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving(e.g., receiving information), accessing(e.g., accessing data in a memory) and the like. Also, “determining” may include resolving, selecting, choosing, establishing and the like.

The methods disclosed herein comprise one or more steps or actions for achieving the methods. The method steps and/or actions may be interchanged with one another without departing from the scope of the claims. In other words, unless a specific order of steps or actions is specified, the order and/or use of specific steps and/or actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor. Generally, where there are operations illustrated in figures, those operations may have corresponding counterpart means-plus-function components with similar numbering.

The following claims are not intended to be limited to the embodiments shown herein, but are to be accorded the full scope consistent with the language of the claims. Within a claim, reference to an element in the singular is not intended to mean “one and only one” unless specifically so stated, but rather “one or more.” Unless specifically stated otherwise, the term “some” refers to one or more. No claim element is to be construed under the provisions of 35 U.S.C. § 112(f) unless the element is expressly recited using the phrase “means for” or, in the case of a method claim, the element is recited using the phrase “step for.” All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

What is claimed is:

1. A method, comprising:
formulating two or more insights from a data frame;
assigning a respective score for each respective insight of the two or more insights based on a significance of each respective insight and a confidence in each respective insight; and
searching for an optimal insight among the two or more insights based on the respective score for each respective insight.

2. The method of claim 1, further comprising representing each respective insight of the two or more insights as a conditional test of hypothesis.

3. The method of claim 2, wherein the significance of each respective insight is computed based on a p-value of each respective insight.

4. The method of claim 1, further comprising computing the confidence in each respective insight based on a power of the respective insight at a minimum detectable effect.

5. The method of claim 1, wherein:
the data frame comprises two or more rows of data; and
the confidence of each respective is computed based on a proportion of rows of the data frame satisfying the respective insight to rows of the data frame not satisfying the respective insight.

6. The method of claim 1, wherein searching for the optimal insight among the two or more insights based on the respective score for each respective insight comprises:
growing a tree over the data frame utilizing a greedy binary search algorithm, comprising:
selecting a first node for the tree based on one of the two or more insights based on a maximum of the respective score for each respective insight;
determining a branch for the first node based on two or more additional insights from the data frame based on the first node; and
selecting a second node based on one of the two or more additional insights based on a maximum of a respective score for each respective insight of the two or more additional insights.

7. The method of claim 1, wherein searching for the optimal insight among the two or more insights based on the respective score for each respective insight comprises utilizing a gradient based search.

8. The method of claim 1, further comprising generating a human language representation of the optimal insight with a large language model.

9. The method of claim 1, wherein the respective score for each respective insight of the two or more insights comprises a harmonic mean of the significance of each respective insight and the confidence in each respective insight.

10. The method of claim 1, wherein the respective score for each respective insight of the two or more insights comprises a geometric mean of the significance of each respective insight and the confidence in each respective insight.

11. A method, comprising:
formulating two or more insights from a data frame;
assigning a respective score for each respective insight of the two or more insights based on a significance of each respective insight and a confidence in each respective insight;
searching for an optimal insight among the two or more insights based on the respective score for each respective insight, comprising growing a tree over the data frame utilizing a greedy binary search algorithm, comprising:
selecting a first node for the tree based on one of the two or more insight based on a maximum of the respective score for each respective insight;
determining a branch for the first node based on two or more additional insights from the data frame based on the first node; and
selecting a second node based on one of the two or more additional insights based on a maximum of a respective score for each respective insight of the two or more additional insights; and
generating a human language representation of the optimal insight with a large language model.

12. The method of claim 11, wherein selecting the first node and selecting the second node are further based on utilizing a greedy binary search approach.

13. The method of claim 11, further comprising representing each respective insight of the two or more insights as a conditional test of hypothesis.

14. The method of claim 13, wherein the significance of each respective insight is computed based on a p-value of the respective insight.

15. The method of claim 11, further comprising computing the confidence in each respective insight based on a power of the respective insight at a minimum detectable effect.

16. The method of claim 11, wherein:
the data frame comprises two or more rows of data; and
the confidence of each respective insight is computed based on a proportion of rows of the data frame satisfying the respective insight to rows of the data frame not satisfying the respective insight.

17. The method of claim 11, wherein the respective score for each respective insight of the two or more insights comprises a harmonic mean of the significance of each respective insight and the confidence in each respective insight.

18. The method of claim 11, wherein the respective score for each respective insight of the two or more insights comprises a geometric mean of the significance of each respective insight and the confidence in each respective insight.

19. A processing system, comprising: a memory comprising computer-executable instructions; and a processor configured to execute the computer-executable instructions and cause the processing system to:
formulate two or more insights from a data frame;
assign a respective score for each respective insight of the two or more insights based on a significance of each respective insight and a confidence in each respective insight; and
search for an optimal insight among the two or more insights based on the respective score for each respective insight.

20. The processing system of claim 19, wherein the processor is further configured to cause the processing system to utilize a greedy binary search approach in order to search for the optimal insight among the two or more insights based on the respective score for each respective insight.
